(19) United States
(12) Patent Application Publication
(10) Pub. No.: US 2022/0383121 A1
(43) Pub. Date: Dec. 1, 2022

(54) DYNAMIC ACTIVATION SPARSITY IN NEURAL NETWORKS

(71) Applicant: Applied Materials, Inc., Santa Clara, CA (US)

(72) Inventors: Tameesh Suri, San Jose, CA (US); Bor-Chau Juang, Santa Clara, CA (US); Nathaniel See, Fremont, CA (US); Bilal Shafi Sheikh, Sunnyvale, CA (US); Naveed Zaman, Saratoga, CA (US); Myron Shak, San Jose, CA (US); Sachin Dangayach, Bangalore (IN); Udaykumar Diliprao Hanmante, Udgir (IN)

(73) Assignee: Applied Materials, Inc., Santa Clara, CA (US)

(21) Appl. No.: 17/330,096

(22) Filed: May 25, 2021

(51) Int. Cl. G06N 3/08; G06N 3/063

(52) U.S. Cl. CPC G06N 3/082; G06N 3/063

(57) ABSTRACT

A method of inducing sparsity for outputs of neural network layer may include receiving outputs from a layer of a neural network; partitioning the outputs into a plurality of partitions; identifying first partitions in the plurality of partitions that can be treated as having zero values; generating an encoding that identifies locations of the first partitions among remaining second partitions in the plurality of partitions; and sending the encoding and the second partitions to a subsequent layer in the neural network.

### TECHNICAL FIELD

This disclosure generally describes inducing sparsity in neural network computations to reduce memory bottlenecks. Specifically, this disclosure describes methods and systems for partitioning layer outputs and inducing sparsity on a per-partition basis.

### BACKGROUND

A neural network can be generally defined as a series of sequential operations that identify underlying relationships in a set of input data. Neural networks process information in a way that models ways in which the human mind operates. Therefore, intermediate stages in neural networks may use computational elements referred to as neurons. Connections between neurons operate like synapses in a biological system to transmit intermediate computations between neuron layers. The outputs of each neuron may be computed using different types of functions that combine the different synapse inputs. Synapses may be weighted at the inputs of each neuron, and these weights may be set using a training process. Neural networks are trained by processing example data with known results to form probability-weighted associations between the inputs and outputs that are stored within the data structure of the network itself as weights or parameters. Training can take place in a supervised learning environment using training data, or training may be unsupervised using input data received during use.

Computational hardware has been designed to optimize the processing of input data through neural network functions. For example, a neural network compiler may receive a code-based definition of a neural network and generate instructions for one or more compute nodes in a hardware neural network accelerator. The compute nodes on the accelerator may include individual chiplets or other computational blocks that process neural network operations efficiently in parallel. Outputs from each layer of the neural network may be stored in temporary buffers or on-chip memories after intermediate results have been received, then passed to subsequent layers in the neural network. However, as the computational demands and input sizes of modern neural networks continue to increase, memory storage between layers is rapidly becoming a serious bottleneck, and the demands of parallel processing are becoming difficult to manage. Therefore, improvements are needed in this technology.

### SUMMARY

In some embodiments, a method of inducing sparsity for outputs of neural network layer may include receiving outputs from a layer of a neural network; partitioning the outputs into a plurality of partitions; identifying first partitions in the plurality of partitions that can be treated as having zero values; generating an encoding that identifies locations of the first partitions among remaining second partitions in the plurality of partitions; and sending the encoding and the second partitions to a subsequent layer in the neural network.

In some embodiments, a neural network accelerator may include a compute node configured to implement a layer of a neural network and generate outputs from the layer, and a partitioning circuit configured to perform operations including receiving outputs from the layer of a neural network; partitioning the outputs into a plurality of partitions; identifying first partitions in the plurality of partitions that can be treated as having zero values; and generating an encoding that identifies locations of the first partitions among remaining second partitions in the plurality of partitions. The neural network accelerator may also include a memory configured to store the encoding and the second partitions for a subsequent layer in the neural network.

In some embodiments, a method of inducing sparsity for outputs of neural network layer may include receiving outputs from a layer of a neural network, and partitioning the outputs into a plurality of partitions, where each of the plurality of partitions comprises a plurality of the outputs. The method may also include identifying first partitions in the plurality of partitions that satisfy a criterion indicating that values in the first partitions may be set to zero; generating an encoding that identifies locations of the first partitions among remaining second partitions in the plurality of partitions; sending the encoding and the second partitions to a subsequent layer in the neural network and discarding the first partitions; receiving the second partitions at the subsequent layer in the neural network; arranging the second partitions with zero values based on the encoding; and executing the subsequent layer in the neural network.

In any embodiments, any and all of the following features may be implemented in any combination and without limitation. The method/operations may also include receiving the second partitions at the subsequent layer in the neural network; and arranging the second partitions based on the encoding. The subsequent layer may perform a multiplication operation, whereby the first partitions can be discarded as a multiply-by-zero operation. The outputs may include a three-dimensional array of outputs from the layer, wherein the array of outputs comprises a dimension for different channels in the neural network. The plurality of partitions may include three-dimensional partitions of the array of outputs. The first partitions need not be contiguous in the plurality of partitions. Identifying the first partitions in the plurality of partitions that can be treated as having zero values may include receiving a criterion from a design environment; and applying the criterion to each of the plurality of partitions. The criterion may include a relative magnitude function calculates an aggregate for the values in a partition and sets the values in the partition to zero if the aggregate is less than a threshold. The criterion may be sent as a runtime function from the design environment. The criterion may be encoded as part of a graph representing the neural network. The neural network accelerator may also include a plurality of chiplets, where the compute node may be implemented on a first chiplet in the plurality of chiplets, and wherein the subsequent layer may be implemented on a second chiplet in the plurality of chiplets. The neural network accelerator may also include sequencer circuit configured to perform operations including receiving the second partitions at the subsequent layer in the neural network, and arranging the second partitions based on the encoding. The layer of the neural network may include executing a convolution core. The memory may include an on-chip static random-access memory (SRAM). The partitioning circuit need not be used when training the neural network. A number of partitions in the plurality of partitions may be determined during training of the neural network. Identifying the first partitions in the plurality of partitions that can be treated as having zero values may include receiving a criterion from a design environment; and applying the criterion to each of the plurality of partitions. The outputs may include a three-dimensional array of outputs from the layer, where the array of outputs may include a dimension for different channels in the neural network, and where the plurality of partitions may include three-dimensional partitions of the array of outputs.

### BRIEF DESCRIPTION OF THE DRAWINGS

A further understanding of the nature and advantages of various embodiments may be realized by reference to the remaining portions of the specification and the drawings, wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 illustrates a graph of the compute scaling for different neural network architectures or models.

FIG. 2 illustrates a chart of the activation density distribution for each channel in a sample neural network.

FIG. 3 illustrates a diagram of a combined algorithm-to-hardware approach to optimally exploit activation sparsity, according to some embodiments.

FIG. 4 illustrates a generic neural network accelerator, according to some embodiments.

FIG. 5 illustrates an improved neural network accelerator that induces sparsity, according to some embodiments.

FIG. 6 illustrates an example of how filters of a convolution operation may generate a multidimensional output array that can be partitioned by the partitioning circuit, according to some embodiments.

FIG. 7 illustrates how the output tensor may be partitioned in any dimension.

FIG. 8 illustrates the improvement that partition-induced sparsity provides over the random sparsity found in an output activation map, according to some embodiments.

FIG. 9 illustrates multi-tile or AI-chiplet architecture, according to some embodiments.

FIG. 10 illustrates a flowchart of a method for inducing sparsity for outputs of a neural network layer, according to some embodiments.

FIG. 11 illustrates an exemplary computer system, in which various embodiments may be implemented.

### DETAILED DESCRIPTION

Artificial Intelligence (AI) continues to become more ubiquitous. As its use becomes more widespread, AI is enabling new use cases that were previously believed to be too complex. his increasing adoption of AI across many different disciplines is driving the performance requirements needed from both AI hardware and software. For example, new algorithms continue to solve more complex use cases from computer vision (CV) and natural language processing (NLP), and the demand for growth in compute power and memory storage is being stretched beyond what can be supported with conventional process scaling alone. Future improvements to the efficiency of AI systems will likely result in innovations that affect different levels of the technology stack together, rather than innovations to hardware, software, training, etc., alone.

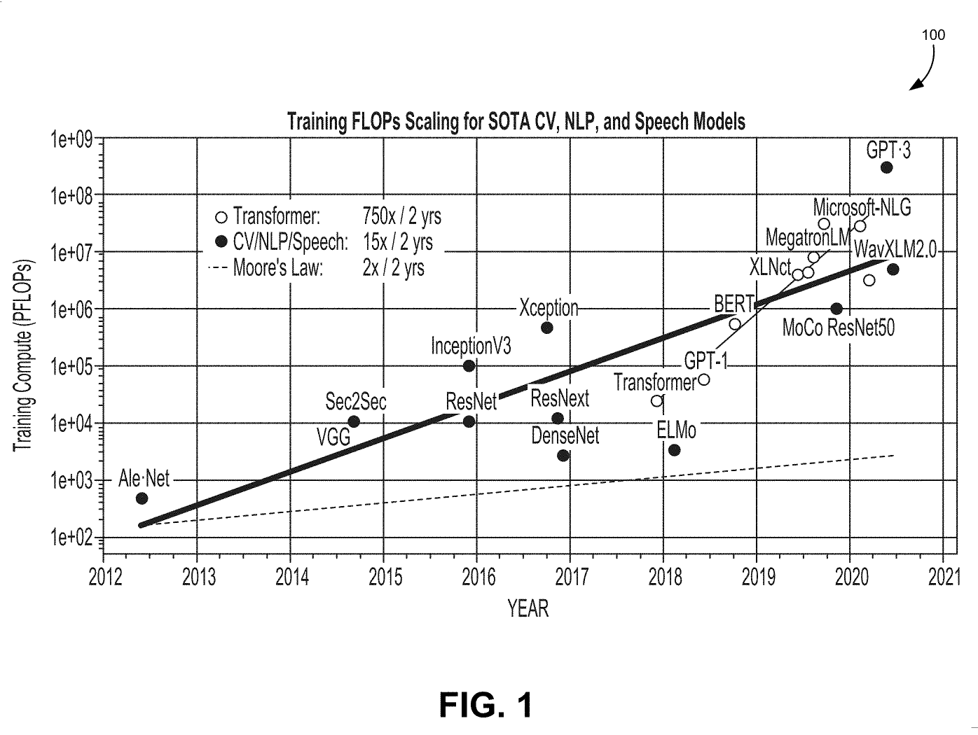

FIG. 1 illustrates a graph 100 of the compute scaling for different neural network architectures or models. This graph 100 summarizes the compute growth for different CV and NLP neural network models in recent years. Note that the growth in compute requirements for CV, NLP, and/or speech recognition have been rapidly outpacing the natural growth of computational power that follows from Moore's law. This discrepancy becomes even more pronounced when considering transformer-based neural networks for which the compute requirements are growing at an even faster rate. Although the absolute floating-point operations (FLOPS) metric represented in FIG. 1 is specifically related to neural network training, the overall compute scaling trend is the same for both training and inference calculations performed by the neural networks. The demands of performance scaling illustrated in FIG. 1 become even more pronounced when using smart edge devices with limited computational power compared to computations performed on a data center or a cloud platform.

It is evident that traditional compute and memory scaling will be unable to support the growth and adoption of AI demands in the future. Although there are ongoing efforts for different portions of the AI stack, from neural network algorithms to hardware implementations, most of these efforts are static in nature. Existing optimization efforts are often centered around parameter-based model compression approaches, such as quantization or pruning. Alternatively, optimization efforts have focused exclusively on the algorithmic level, such as knowledge distillation or low-rank factorization. While these separate methods individually offer reductions in memory and computer usage, the overall efficiency is limited due to the course level of the optimizations and the accuracy trade-offs that limit these improvements to specific input data sets or models.

The performance demands can be exacerbated as models become deeper with more internal layers and input tensors continuing to scale upwards in size. For example, the ResNet-152 model may include 152 internal layers, input tensors may include high-resolution images, and inputs may be patched together from multiple sources, such as multiple camera streams. With these large data sets, activation memory sizes are becoming a primary bottleneck and are exceeding even the parameter memory sizes that store weights and parameters for the neural network. As used herein, parameter memory refers to the storage of weights and parameters for the neural network itself, whereas activation memory refers to the dynamic input/output of tensors that flow through a neural network. Conventional model compression techniques such as quantization, weight pruning, etc., are focused only on the parameter memory and not on the activation memory, thus leaving this bottleneck unsolved.

General solutions for solving the activation memory bottleneck are currently not found in neural network technologies. Specifically, since most neural networks use some form of nonlinearity (, e.g., ReLU, Sigmoid, Tanh, etc.) as part of each layer, the activation outputs from each layer will have a natural occurring level of sparsity. In other words, these activation functions tend to force many values, such as negative values, to zero as the activation functions are executed. However, this sparsity is dynamic. Unlike sparsity in parameter weights in the neural network, this sparsity will differ with each input tensor, making the location of such sparsity impossible to predict at design time. This makes exploiting the dynamic activation sparsity very challenging in hardware, and conventional hardware accelerators do not support this type of optimization.

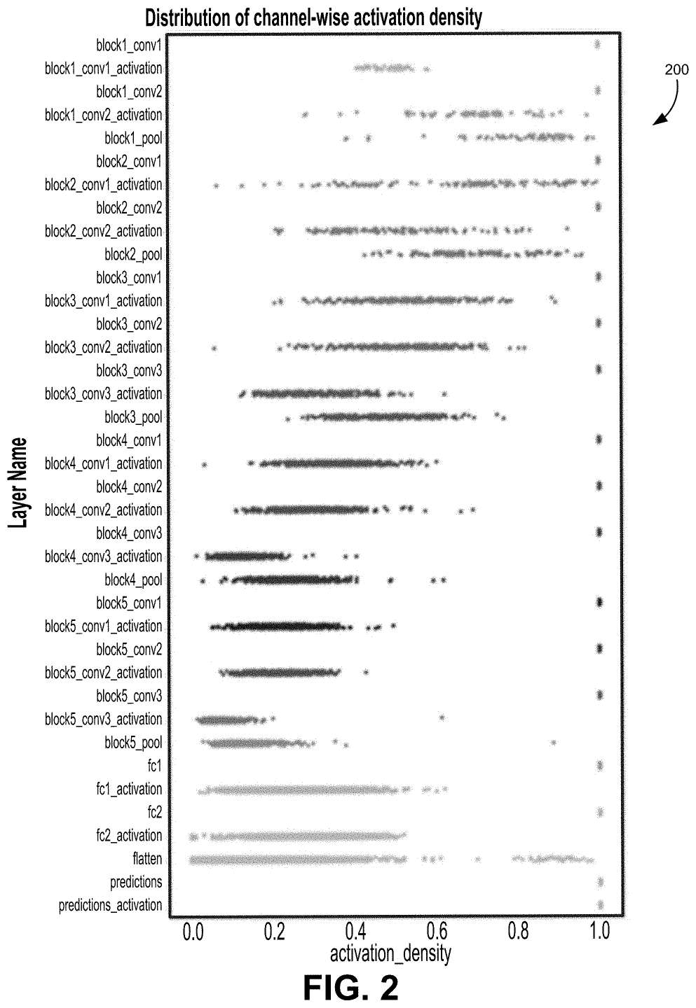

FIG. 2 illustrates a chart 200 of the activation density distribution for each channel in a sample neural network. The data in chart 200 is sourced from the VGG-16, which is a popular image-classification neural network based on a convolution architecture. Each channel on the Y-axis represents a unique neural network layer, and each dot on the chart 200 represents the density per channel. It can be observed that the activation distributions are highly irregular and non-uniform for channels across most layers in the neural network. In other words, the sparsity in different channels is unpredictable and largely dependent on the runtime inputs. Additionally, chart 200 reveals another challenge that results from non-uniform dynamic distributions of sparsity referred to herein as the “tail worker” effect. Specifically, the tail-worker effect limits the overall speed up to the slowest or “tail” worker. This results in a limited upside to exploiting activation sparsity to improve performance since most hardware accelerators divide or split the neural network layers into multiple smaller kernels that are executed in parallel on parallel processing elements.

Similarly, the unpredictable distribution of sparsity in the activation output limits the memory savings that may be realized by removing zero values. Specifically, if sparse zero values are removed from the activation map, then the respective encoding of removed elements still needs to be preserved. In other words, encoding must be preserved that specifies which zero elements have been removed such that the original set of outputs can be reconstructed as inputs to a subsequent layer. This means that memory savings will be unlikely to be achieved without at least 50% sparsity, and activation tensors below this threshold may actually result in an increase of memory usage and bandwidth.

The embodiments described herein propose a general-purpose architectural framework and a holistic algorithm-to-hardware approach to exploit dynamic activation sparsity in neural networks. This architecture introduces and induces “structured sparsity” in an activation feature map (e.g., an output of a layer), where the structure of the sparsity is tailored to the underlying execution unit of the architecture by creating partitions in the layer outputs. For example, each execution unit, including SIMD, VLIW, systolic arrays, convolution engines, MAC operations, etc., may have tailored partition types and sizes. Each of these different operations may also have individual criteria that are used to induce sparsity and set entire partitions to zero. The use of this structure tailored to the underlying organization of the corresponding execution unit at the algorithm and framework level may generate an optimal design point to be targeted for optimizing computer usage, memory capacity, and interconnect bandwidth.

Sparse partitions do not need to be stored in memory between activation layers. In addition to memory savings, compute operations with sparse activations can also be eliminated. For example, an input to a compute node that multiplies and input tensor by a specific weight can be eliminated when the entire input tensor is set to zero, and thus this compute operation can be completely skipped in subsequent layers. This can result in a significant compute reduction in the neural network. Additionally, with the slowness of Moore's law and the adoption of heterogeneous chiplet-based solutions to support the growing compute needs of AI, these embodiments that exploit activation sparsity can alleviate bandwidth pressures in on-package interconnects. This allows near monolithic-like scaling for AI workloads on chiplet-based architectures, even with the on-package interconnects and reduced densities inherent in these designs.

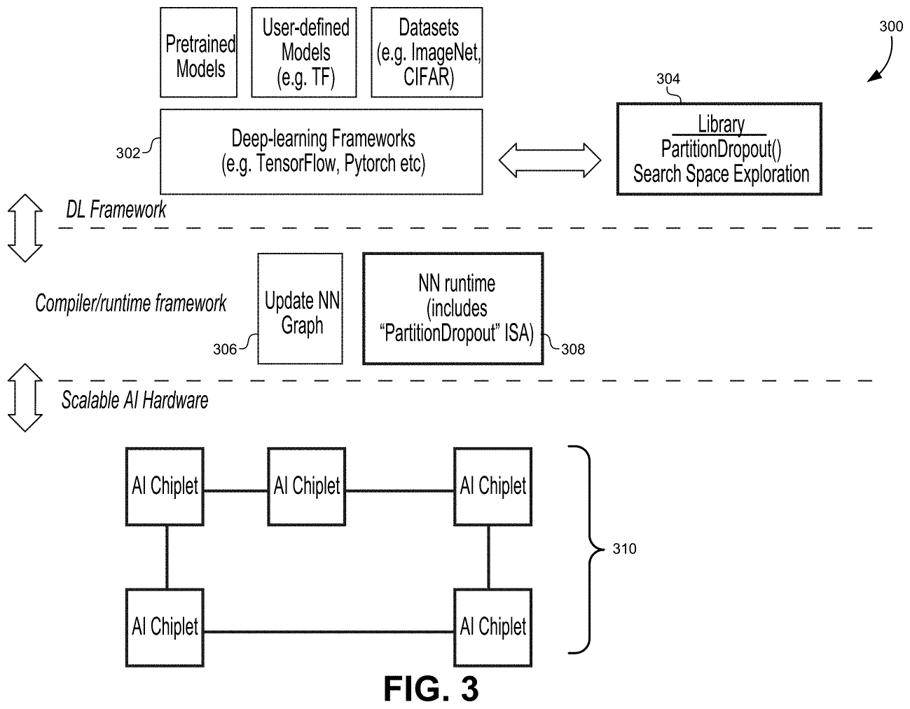

FIG. 3 illustrates a diagram 300 of a combined algorithm-to-hardware approach to optimally exploit activation sparsity, according to some embodiments. The architecture may include a deep learning framework 302. A deep learning frameworks may include user interfaces and libraries/tools that allow users to easily build deep learning models. Examples of deep learning frameworks 302 may include TensorFlow®, PyTorch®, Keras®, Sonnet®, and/or other commercially available tools. The deep learning framework may draw from pre-trained models, user-defined models, and/or sample data sets for developing new neural networks for specific applications.

Some embodiments may add a custom library 304 that is referred to herein as

“PartitionDropout,” which may integrate with the deep learning framework 302. The PartitionDropout dropout library may be used with pre-trained models, or models can be trained with PartitionDropout added into the design. The library 304 allows a neural network designer to evaluate optimal partition size, compute, memory capacity, and/or bandwidth reduction trade-offs during the design process.

The PartitionDropout library may be used to add code to configure additional hardware elements in the AI hardware to induce sparsity in the activation maps of various layers. For example, this library 304 may allow the user to specify various sizes and shapes of partitions for the outputs from a layer. Additionally, the library 304 may allow the neural network designer to specify a criterion or function that determines or identifies partitions in the layer output that can be treated as having zero values. These two parameters (i.e., the partitioning scheme and the criterion) may be set experimentally or chosen by the neural network designer.

For example, some embodiments may process sample data with a neural network using a list of possible partition sizes and structures. The resulting simulated outputs may then be characterized in terms of bandwidth, compute, and/or memory savings as a trade-off with accuracy compared to simulated results using other partition sizes/structures. An optimal partition size/structure may then be selected from the simulated results. Similarly, the criterion used may be simulated using different thresholds to identify an optimal inflection point in the trade-off between accuracy and resulting hardware efficiency. For example, a magnitude-based criteria may calculate an aggregate for the values in the partition and set all the values in the partition to zero if the aggregate is less than a threshold. This threshold may be adjusted up/down during simulation to find an optimal value.

Per-network or per-layer metadata may need to be communicated with the underlying hardware in order for the hardware to implement the scheme designed in the deep learning framework as described above. For example, the selected criterion and thresholds along with a partition size or structure may need to be communicated from the deep learning framework 302 to the hardware 310. The architecture 300 provides a number of different methods for providing this communication. In some embodiments, the compiler may incorporate the partitioning and/or the criterion into the neural network graph 306 that is transmitted to the hardware 310. The compiled neural network graph 306 may include instructions to perform the operations of the

PartitionDropout layer after a compute layer executes. For example, a partitioning circuit that is executed after the compute operations of a layer in the neural network may be treated as part of the neural network by the compiler, and the instructions to generate the partition and execute the criterion to induce sparsity may be implemented as part of the neural network graph 306. Alternatively, some embodiments may send a neural network runtime that includes the

PartitionDropout instruction set architecture (ISA). A neural network runtime 308 may be sent to the hardware 310 to separately program the partitioning circuit in the AI accelerator or other hardware.

Finally, the hardware 310 may execute the graph with the PartitionDropout partitioning and/or criterion as described above. For example, the hardware 310 may include a multi-tile or AI chiplet solution were a neural network or layer is distributed over different AI tiles or chiplets. As described below, the hardware 310 may include circuits that implement the criterion and/or partitioning function specified in the deep learning framework 310. These partitioning circuits may be included after any and/or all layers implemented by compute nodes in the hardware 310.

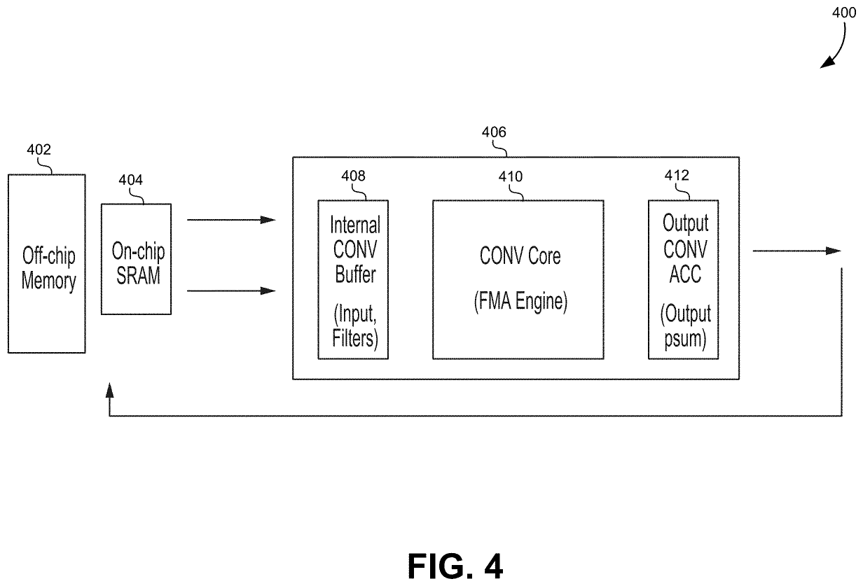

FIG. 4 illustrates a generic neural network accelerator 400, according to some embodiments. The architecture may include an on-chip SRAM 404 and/or an off-chip memory 402. These memories may store input/output tensors as they propagate through the various layers of the neural network. A execution unit 406 may perform one or more of the operations of one or more layers of the neural network. In this example, the execution unit 406 may include an internal input buffer 408 that receives an input tensor from a previous compute node or from an input to the neural network. The input buffer 408 may include filters with partial spatial dimensions and channel dimensions and some cases. The input buffer 408 may provide the tensor to a compute core or compute node 410 that performs one or more operations on the input tensor received from the input buffer 408. For example, the compute node 410 may perform a convolution operation and may be implemented using a floating-point multiply-add (FMA) engine. The outputs of the compute node 410 may be passed to an output buffer 412. The output buffer may accumulate convolution results from the compute node 410. Partial sums that are generated by the compute node 410 may spill over from the output buffer 412 into the on-chip SRAM 404, and further onto the off-chip memory 402.

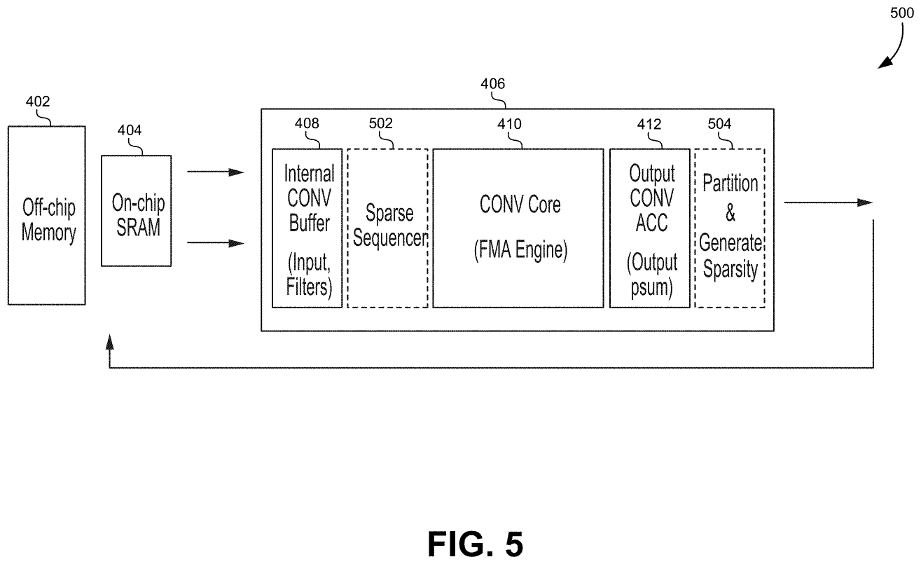

FIG. 5 illustrates an improved neural network accelerator 500 that induces sparsity, according to some embodiments. This neural network accelerator 500 may include the components described above for the neural network accelerator 400 of FIG. 4. However, this neural network accelerator 500 may also include a partitioning circuit 504 configured to generate sparsity in the outputs of the compute node 410, along with a sequencer circuit 502 configured to sequence inputs when sparse partitions have been removed. The partitioning circuit 504 and the sequencer circuit 502 may be programmed using the neural network graph and/or using the metadata from the runtime provided by the deep learning framework as described above.

The partitioning circuit may receive outputs from a layer of a neural network. This layer may be implemented by the compute node 410, and may perform different mathematical functions, such as activation functions, convolution functions, and so forth. Outputs from the compute node 410 may be received and/or accumulated in the output buffer 412. The partition circuit 504 may then perform a number of actions. First, the partition circuit 504 may partition the outputs into a plurality of different partitions. The partition structure/size may be determined in the deep learning framework and passed to the partition circuit 504 as described above.

Examples of how an activation map tensor may be partitioned are provided below. Note that partitioning the outputs into the plurality partitions does not necessarily require any actual values or memory elements to be moved or changed. Instead, the partitioning circuit 504 may identify partitions as groups of values according to a predetermined partitioning size/structure and may execute a criterion or otherwise handle each partition together as a single entity.

The partitioning circuit may also identify partitions in the plurality partitions that can be treated as having zero values. This operation may be carried out in a number of different ways. In some embodiments, the criterion received from the deep learning framework may be executed on each partition. A purpose of the criterion may be to determine whether the partition as a whole includes small enough values that the partition may be treated as having only zero values. For example, if the values in a 2×2×6 partition have an aggregated total of less than 0.1, then all of the values in the partition may be treated as zero. Note that this disclosure does not limit the type of criterion that may be used. One example of the criterion is a criterion that aggregates the values in each partition and compares the aggregated value to a threshold, treating the partition as zero values if the aggregate is below the threshold. Other embodiments may use a different criterion. Also note that the criterion may be executed alone or with other criterion as a set of criteria. Therefore, any reference to a single criterion also allows for multiple criteria to be executed on the partition in any combination.

Treating a partition as having zero values may include writing actual zero values (e.g., 0.0) into each of the storage locations in the partition. This operation may overwrite any values that were previously stored as outputs of the compute node 410. Note that this may be a lossy procedure that may result in at least some loss of accuracy. However, neural network operations can tolerate a small loss of accuracy at intermediate layers. This operation can also be distinguished from activation functions or other functions are executed on individual memory locations one-at-a-time. Instead of comparing a single value to a threshold and setting it to zero, this operation sets the values of an entire partition to zero (or treats them as zero). Thus, a relatively large non-zero value in a single location may be set to zero in the partition if the criterion for the partition dictates such.

In some embodiments, treating a partition as having zero values need not require writing any actual zero values into the storage locations of the partition. Instead, the partition may be treated as having zero values. For example, the partition may be discarded and not passed on to a subsequent layer or to the on-chip SRAM 404. Whether actual zero values are written to the memory locations of the partition or not, these partitions may be discarded when storing the outputs to memory. For example, when storing the partitions to memory, the partitioning circuit 504 may generate an encoding that identifies locations of partitions that are treated as having zero values in the overall output array. For example, a binary string may be generated with a single bit associated with each partition. A 0 value may indicate that the partition should be treated as having zero values, while a 1 value may indicate that the partition should be treated as having non-zero values that are stored in memory. Instead of storing all of the partitions to memory, a first set of partitions (“first partitions”) that are treated as having zero values may be discarded, while a second set of partitions (“second partitions”) having non-zero values may be stored in memory. This encoding may generate tremendous memory savings and reduce the memory bottleneck that results from very large output tensors. For example, a 3D output array divided into 25 partitions may induce sparsity in, for example, 10 of those partitions. Instead of storing 25 partitions full of values, the partitioning circuit 504 only needs to store 15 partitions with a 25-bit string that encodes the output.

Some embodiments have induced an average sparsity of 40% in each layer. When this sparsity is induced in partitions as described above, this results in a 40% savings in activation memory. In edge devices with constraints on on-chip memory resources, this reduction can be translated directly into performance savings in non-chip and off-chip memory bandwidth. This improves memory access times and improves the overall speed of the neural network operation by minimizing the number memory transfers for each operation.

The partitioning circuit 504 may send the encoding and the second set of partitions having non-zero values to a memory (e.g., the on-ship SRAM 404). Alternatively, the partitioning circuit 504 may send the outputs directly to another input buffer 408 of a subsequent layer or compute node in the neural network.

When a subsequent layer receives the encoded tensor from the partitioning circuit 504, the sequencer circuit 502 may decode the tensor to provide the second set of partitions in the right locations for processing. The sparse-formatted tensor may be read and control logic in the sequencer circuit 502 can select different partitions to be sent to this or other execution units. For example, the sequencer circuit 502 may read the encoding and insert partitions full of zero values into the input tensor as needed. The sequencer circuit 502 may reassemble the tensor such that it of the expected size, with the non-zero values appearing in the expected place an order in the input tensor.

In addition to saving memory bandwidth, this partitioning may also eliminate some of the compute operations performed by the neural network accelerator 500. In some embodiments, individual partitions may be sent to different execution units 406. If an operation is to receive a partition that has been set to zero values or otherwise should be treated as having zero values, that operation may be eliminated in some instances. For example, if the operation at the compute node involves a multiplication operation, the zero partition may cause the outputs of that operation to be zero. Thus instead of actually performing the operation, the zero outputs can be generated without performing the multiplication operation, and the corresponding compute stage may be eliminated. With non-contiguous tensors, the respective output buffers may be selected based on the input tensor structure in the encoding. This control logic in the sequencer circuit 502 may perform this operation.

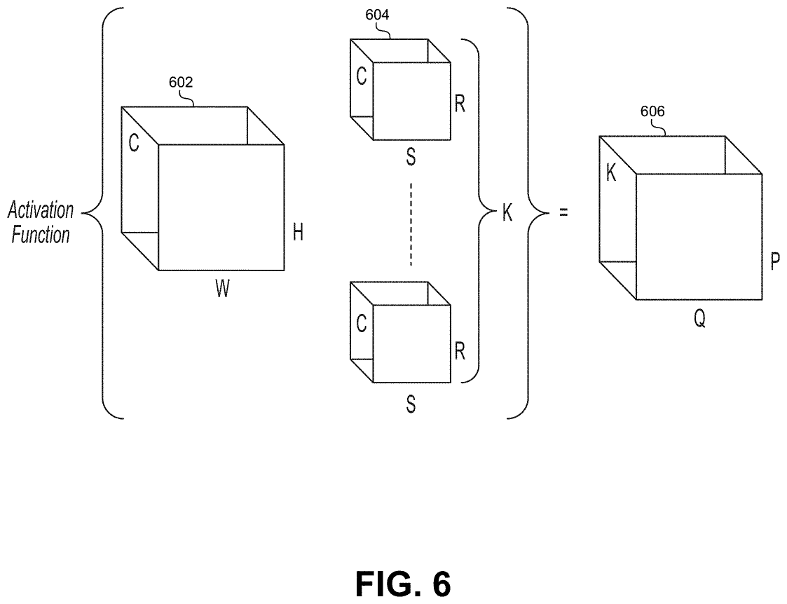

FIG. 6 illustrates an example of how filters of a convolution operation may generate a multidimensional output array that can be partitioned by the partitioning circuit, according to some embodiments. An input tensor 602 for an activation function may have spatial dimensions of H×W (height x width) with multiple input channels C, thus yielding a three-dimensional input array. A spatial convolution may be performed by the activation function using a plurality of filters 604. Each of the filters may have dimensions R×S, with the same number of channels C as the input tensor 602. The activation function may apply K different filters during the convolution operation. The resulting output tensor 606 may be characterized as a P×Q two-dimensional array for each of the K filters is 604.

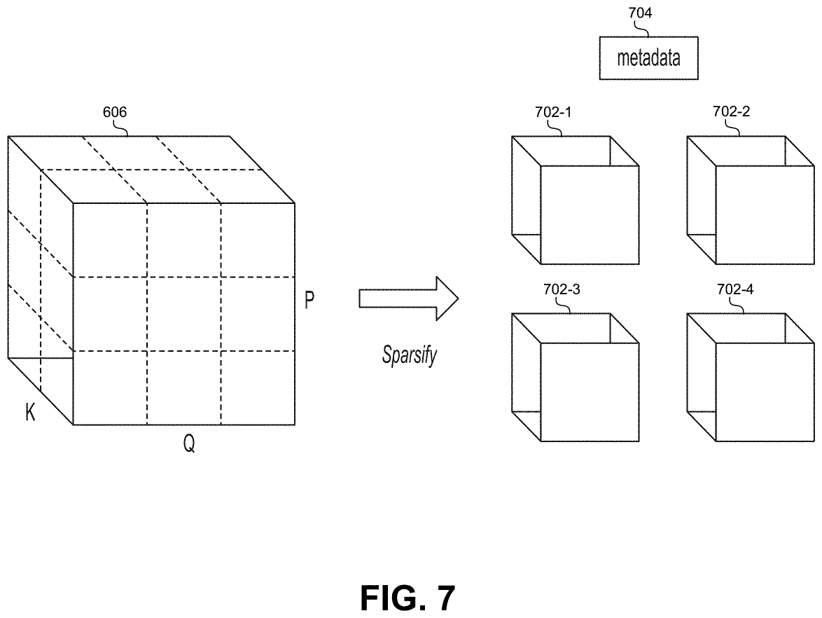

FIG. 7 illustrates how the output tensor 606 may be partitioned in any dimension. Note that partitions may split the output tensor 606 across both spatial and channel dimensions resulting in 2D or 3D partitions. Note that the partitions illustrated in FIG. 7 are provided only by way of example and are not meant to be limiting. Any structure or size for partitions may be used. It should also be noted that as different partitions are designed, the communication patterns between different compute nodes in the neural network accelerator will change. For example, as partitions change, the locations where certain partitions should be sent as a block in the neural network may also change based on the individual design of the neural network. This routing information may also be provided from the deep learning framework to the hardware components of the neural network accelerator such that partitions are routed to the correct locations.

After applying the criterion and inducing sparsity on the various partitions in the output tensor 606, the partitioning circuit may reduce the 18 partitions in the output tensor 606 to four non-sparse partitions 702. Metadata 704 may store the encoding such that the original output tensor 606 can be represented/recreated and the non-sparse partitions 702 can be sent to the right compute nodes. The encoding in the metadata 704 may also be used to generate sparse partitions if needed for some subsequent layer operations.

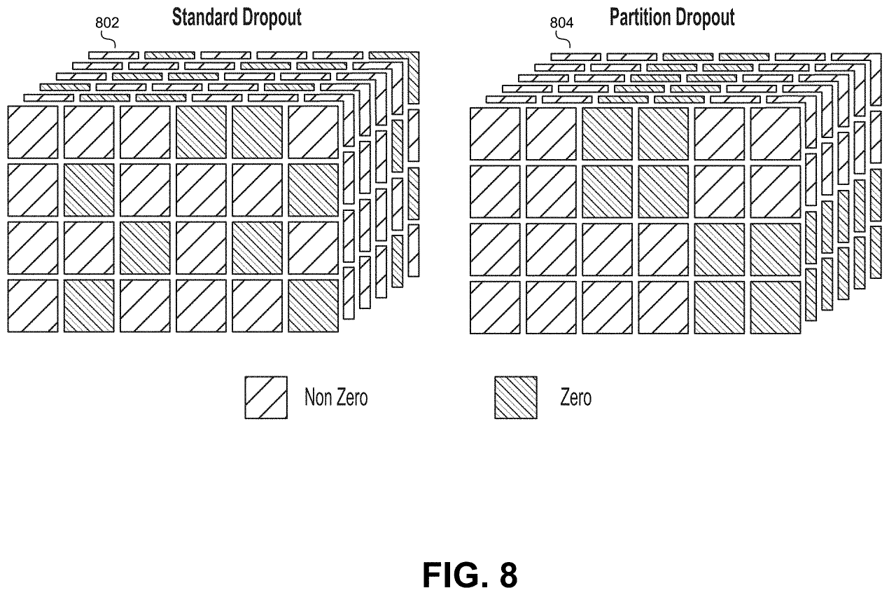

FIG. 8 illustrates the improvement that partition-induced sparsity provides over the random sparsity found in an output activation map, according to some embodiments. Although some regularization techniques (e.g., L1/L2, dropout, etc.) or modified activation functions (e.g., FATReLU) have been shown to increase activation sparsity, the sparsity induced by these functions is still random in nature and difficult to be utilized by a system-level architecture, as illustrated by the activation map 802 using these standard dropout techniques. The new intermediate layer introduced herein (the partitioning circuit and the sequencer circuit) provides a structured dropout technique that can be used to enforce a certain proportion of the activation map to be completely sparse. This new layer is designed to be deterministic and applied during training and/or inference. For example, in a magnitude-based criterion as described above, the activation maps may first be divided into a grid of contiguous partitions that cut across spatial and/or channel dimensions, each of which may be treated as having zero values and dropped or retained in its entirety based on the rank of the activation magnitude as illustrated by the activation map 804 using the partition dropout technique. Although this may possibly reduce accuracy, this is not necessarily the case. In some cases, partition-induced sparsity has been shown to obtain a better validation accuracy in comparison to the activation map 802 using standard sparsity. This shows that a partitioned dropout provides a more effective regularization in addition to enabling the hardware acceleration described above.

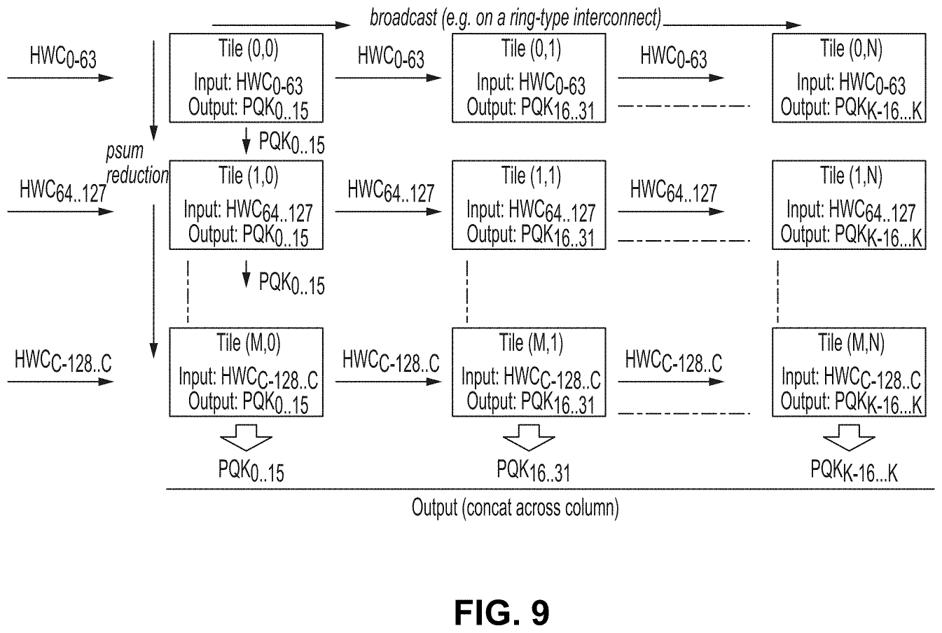

FIG. 9 illustrates multi-tile or AI-chiplet architecture, according to some embodiments. In addition to reducing memory usage and reducing compute usage, the PartitionDropout architecture for a neural network accelerator can also result in significant savings on interconnect bandwidth when scaling across multiple AI dies, tiles, or chiplets. While chiplets solve problems of scaling and cost inherent in large monolithic dies, they typically do not offer the same level of interconnect density and power efficiency as a monolithic die, so breaking up a coherent block, such as an AI accelerator, may result in lower compute scaling compared to monolithic solutions. However, the architecture described herein alleviates the bandwidth pressures on the interconnect between multiple AI dies, tiles, or chiplets. This also improves the performance and power efficiency of AI compute scaling across many different AI chiplets.

FIG. 9 illustrates one such example using multiple AI tiles, chiplets, or dies configured in a 2D mesh topology. In this example, each vertical column may split across the K dimension described above in FIGS. 6-7. For example, tile(0,0) may include filters for K=0-15, tile(0,1) may include filters K=16-31, and so forth. Each horizontal row in the architecture splits across the C dimension, so HCW 0-63 may be broadcast for all the columns in row 0, HCW 64-127 may be broadcast for all of the columns in row 1, and so forth. This may result in each row of a single column producing partial sums with respective K splits. These may all be reduced within a single column to reduce a partial output tensor PKQ that is split among the various columns. Thus, the output of each of the columns represents a portion of the total output tensor, which may be concatenated to form the complete output.

Each AI tile, die, or chiplet represented as a node in FIG. 9 may be implemented to use the neural network accelerator architecture 500 in FIG. 5. Therefore, the outputs of each node may be reduced as the partitions are treated as having zero values and dropout from being propagated through the interconnect between tiles. This results in significant interconnect bandwidth savings in both input and output dimensions.

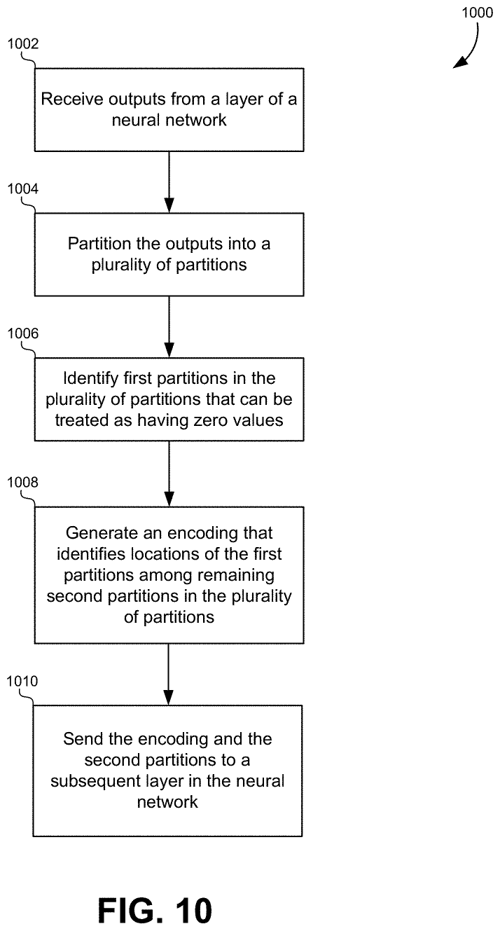

FIG. 10 illustrates a flowchart 1000 of a method for inducing sparsity for outputs of a neural network layer, according to some embodiments. This method may be executed by the neural network accelerator 500 illustrated in FIG. 5 above. Additionally, the partitioning size/structure, the criterion used, and the routing between different nodes implementing the neural network accelerator may be programmed in a deep learning environment or framework as described in FIG. 3.

The method may include receiving outputs from a layer of a neural network (1002). The output may be received by a layer that is added between computational layers of the neural network. This additional layer may be implemented using the partitioning circuit and/or sequencing circuit described above. The outputs from the layer may be received directly from a compute node and/or from an output buffer that receives and/or accumulates values from the compute node.

The method may also include partitioning the outputs into a plurality of partitions (1004). Any type, size, structure, or topology of partitioning may be used. Partitioning may be defined in the deep learning framework and passed to the neural network accelerator as an encoding in a neural network graph or as runtime metadata that programs the additional layers. Partitioning may take place across spatial and/or channel dimensions, and may result in 2D and/or 3D partitions.

The method may additionally include identifying first partitions in the plurality of partitions that can be treated as having zero values (1006). The first partitions may be identified by executing a criterion on each partition as a whole. For example, the criterion may be magnitude-based and may compare an aggregate of the values within the partition to a threshold to determine whether all values in the partition as a whole should be treated as zero. Treating values as zero may include setting actual values in the tensor to 0, or discarding or allowing the partitions to dropout that are treated as zero rather than being stored or propagated to a subsequent layer.

The method may further include generating an encoding that identifies locations of the first partitions among remaining second partitions in the plurality of partitions (1008). The encoding may identify first partitions that should be treated as having zero values and their relative location in the output tensor with the second partitions that are treated as having non-zero values. The encoding may be stored with the second partitions and/or passed to a subsequent layer or compute node in the neural network. The method may then also include sending the encoding and the second partitions to a subsequent layer in the neural network (1010).

It should be appreciated that the specific steps illustrated in FIG. 10 provide particular methods of inducing sparsity for outputs of a neural network layer according to various embodiments. Other sequences of steps may also be performed according to alternative embodiments. For example, alternative embodiments may perform the steps outlined above in a different order. Moreover, the individual steps illustrated in FIG. 10 may include multiple sub-steps that may be performed in various sequences as appropriate to the individual step. Furthermore, additional steps may be added or removed depending on the particular applications. Many variations, modifications, and alternatives also fall within the scope of this disclosure.

Each of the methods described herein may be implemented by a computer system. For example, the deep learning framework may be executed on a computing system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user, or may be done automatically by a computer system without human intervention where any determinations are made by a processor. Furthermore, some embodiments of each of the methods described herein may be implemented as a set of instructions stored on a tangible, non-transitory storage medium to form a tangible software product.

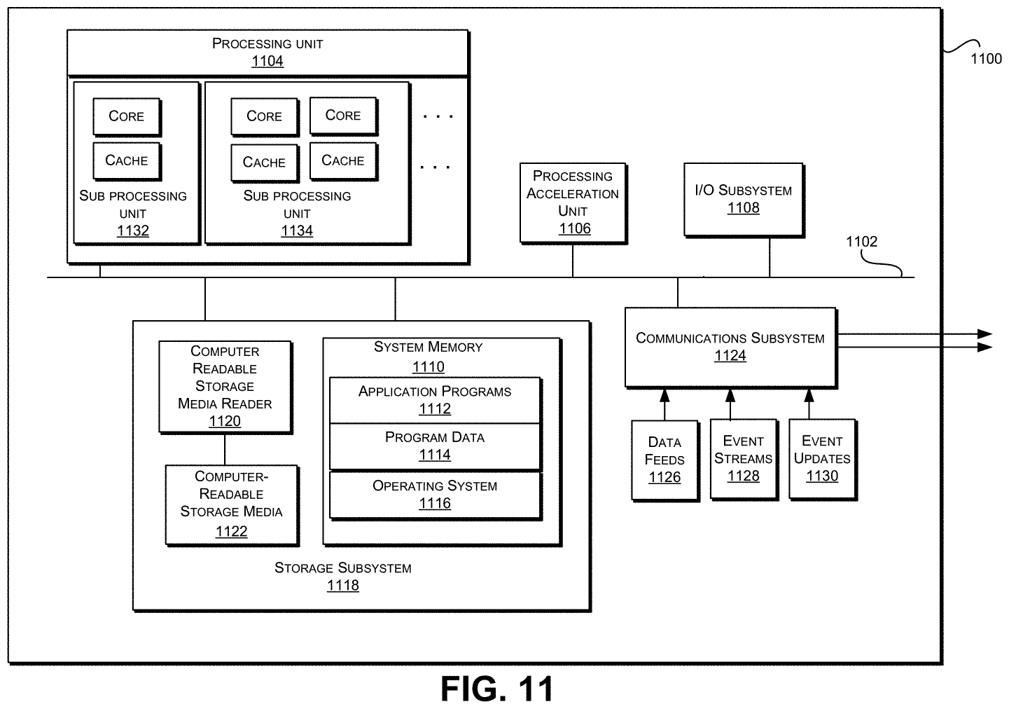

FIG. 11 illustrates an exemplary computer system 1100, in which various embodiments may be implemented. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 1110.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 10 OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with some embodiments.

Storage subsystem 1100 may also include a computer-readable storage media reader 1120 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination.

Further, connection to other computing devices, such as network input/output devices, may be employed. Based on the disclosure and teachings provided herein, other ways and/or methods to implement the various embodiments should be apparent.

In the foregoing description, for the purposes of explanation, numerous specific details were set forth in order to provide a thorough understanding of various embodiments. It will be apparent, however, that some embodiments may be practiced without some of these specific details. In other instances, well-known structures and devices are shown in block diagram form.

The foregoing description provides exemplary embodiments only, and is not intended to limit the scope, applicability, or configuration of the disclosure. Rather, the foregoing description of various embodiments will provide an enabling disclosure for implementing at least one embodiment. It should be understood that various changes may be made in the function and arrangement of elements without departing from the spirit and scope of some embodiments as set forth in the appended claims.

Specific details are given in the foregoing description to provide a thorough understanding of the embodiments. However, it will be understood that the embodiments may be practiced without these specific details. For example, circuits, systems, networks, processes, and other components may have been shown as components in block diagram form in order not to obscure the embodiments in unnecessary detail. In other instances, well-known circuits, processes, algorithms, structures, and techniques may have been shown without unnecessary detail in order to avoid obscuring the embodiments.

Also, it is noted that individual embodiments may have beeen described as a process which is depicted as a flowchart, a flow diagram, a data flow diagram, a structure diagram, or a block diagram. Although a flowchart may have described the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to portable or fixed storage devices, optical storage devices, wireless channels and various other mediums capable of storing, containing, or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In the foregoing specification, features are described with reference to specific embodiments thereof, but it should be recognized that not all embodiments are limited thereto. Various features and aspects of some embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

Additionally, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

What is claimed is:

1. A method of inducing sparsity for outputs of neural network layer, the method comprising:
receiving outputs from a layer of a neural network;
partitioning the outputs into a plurality of partitions;
identifying first partitions in the plurality of partitions that can be treated as having zero values;
generating an encoding that identifies locations of the first partitions among remaining second partitions in the plurality of partitions; and
sending the encoding and the second partitions to a subsequent layer in the neural network.

2. The method of claim 1, further comprising:
receiving the second partitions at the subsequent layer in the neural network; and
arranging the second partitions based on the encoding.

3. The method of claim 2, wherein the subsequent layer performs a multiplication operation, whereby the first partitions can be discarded as a multiply-by-zero operation.

4. The method of claim 1, wherein the outputs comprise a three-dimensional array of outputs from the layer, wherein the array of outputs comprises a dimension for different channels in the neural network.

5. The method of claim 4, wherein the plurality of partitions comprises three-dimensional partitions of the array of outputs.

6. The method of claim 1, wherein the first partitions are not contiguous in the plurality of partitions.

7. The method of claim 1, wherein identifying the first partitions in the plurality of partitions that can be treated as having zero values comprises:
receiving a criterion from a design environment; and
applying the criterion to each of the plurality of partitions.

8. The method of claim 7, wherein the criterion comprises a relative magnitude function calculates an aggregate for the values in a partition and sets the values in the partition to zero if the aggregate is less than a threshold.

9. The method of claim 7, wherein the criterion is sent as a runtime function from the design environment.

10. The method of claim 7, wherein the criterion is encoded as part of a graph representing the neural network.

11. A neural network accelerator comprising:
a compute node configured to implement a layer of a neural network and generate outputs from the layer;
a partitioning circuit configured to perform operations comprising:
receiving outputs from the layer of a neural network;
partitioning the outputs into a plurality of partitions;
identifying first partitions in the plurality of partitions that can be treated as having zero values; and
generating an encoding that identifies locations of the first partitions among remaining second partitions in the plurality of partitions; and
a memory configured to store the encoding and the second partitions for a subsequent layer in the neural network.

12. The neural network accelerator of claim 11, further comprising a plurality of chiplets, wherein the compute node is implemented on a first chiplet in the plurality of chiplets, and wherein the subsequent layer is implemented on a second chiplet in the plurality of chiplets.

13. The neural network accelerator of claim 11, further comprising a sequencer circuit configured to perform operations comprising:
receiving the second partitions at the subsequent layer in the neural network; and
arranging the second partitions based on the encoding.

14. The neural network accelerator of claim 11, wherein the layer of the neural network comprises executing a convolution core.

15. The neural network accelerator of claim 11, wherein the memory comprises an on-chip static random-access memory (SRAM).

16. The neural network accelerator of claim 11, wherein the partitioning circuit is not used when training the neural network.

17. The neural network accelerator of claim 11, wherein a number of partitions in the plurality of partitions is determined during training of the neural network.

18. The neural network accelerator of claim 11, wherein identifying the first partitions in the plurality of partitions that can be treated as having zero values comprises:
receiving a criterion from a design environment; and
applying the criterion to each of the plurality of partitions.

19. The neural network accelerator of claim 11, wherein the outputs comprise a three-dimensional array of outputs from the layer, wherein the array of outputs comprises a dimension for different channels in the neural network, and wherein the plurality of partitions comprises three-dimensional partitions of the array of outputs.

20. A method of inducing sparsity for outputs of neural network layer, the method comprising:
receiving outputs from a layer of a neural network;
partitioning the outputs into a plurality of partitions, wherein each of the plurality of partitions comprises a plurality of the outputs;
identifying first partitions in the plurality of partitions that satisfy a criterion indicating that values in the first partitions may be set to zero;
generating an encoding that identifies locations of the first partitions among remaining second partitions in the plurality of partitions;
sending the encoding and the second partitions to a subsequent layer in the neural network and discarding the first partitions;
receiving the second partitions at the subsequent layer in the neural network;
arranging the second partitions with zero values based on the encoding; and
executing the subsequent layer in the neural network.
